(19) United States
(12) Patent Application Publication
(10) Pub. No.: US 2017/0009750 A1
(43) Pub. Date: Jan. 12, 2017

(54) MODULAR SECTION OF WATER PIPE, WATER PIPE INCLUDING SUCH SECTIONS, AND OCEAN THERMAL ENERGY SYSTEM INCLUDING SUCH A WATER PIPE

(71) Applicant: DCNS, Paris (FR)

(72) Inventor: Christophe Francois Laurent ROYNE, BATZ SUR MER (FR)

(21) Appl. No.: 15/116,295

(22) PCT Filed: Feb. 6, 2015
(86) PCT No.: PCT/EP2015/052554

§ 371 Date: Aug. 3, 2016

(30) Foreign Application Priority Data
Feb. 6, 2014 (FR) 14 00341

(51) Int. Cl. F03G 7/05; F16L 11/10

(52) U.S. Cl. CPC F03G 7/05; F16L 11/10

(57) ABSTRACT

A modular section of water pipe (114) includes:
a deformable membrane (130) able to encompass, in an operational state of the section, a tubular space (132) defining an axial direction (AA′) to conduct water, and
a series (135) of rings (120, (140) extending along the axial direction (AA′) in the tubular space (132), and including:
   two end rings (120), each being at a separate end (116, 118) of the section (114) along the axial direction (AA′), the membrane (130) being fastened to the end rings (120),
   at least one central ring (140), arranged between the two end rings (120), and
   cables (150, 160) connecting each ring (120, 140) to the closest ring (120, 140) along the axial direction (AA′).

### FIELD OF THE INVENTION

The present invention relates to a modular section of a water pipe, comprising a deformable membrane able to encompass, in an operational state of the section, a tubular space defining an axial direction to conduct water, the membrane being able to separate the water present in the tubular space from the water present outside the membrane.

Furthermore, the present invention relates to a water pipe comprising a plurality of such sections. The present invention also relates to an ocean thermal energy system comprising such a water pipe.

### BACKGROUND OF THE INVENTION

Ocean thermal energy (OTE) systems exist that produce electricity, by using the temperature difference between the surface water and the deep water to drive a generator. For example, the temperature of the surface water may reach or even exceed 25 degrees Celsius, while the deep water, which is deprived of solar radiation, remains around 2 or 4 degrees Celsius.

Such systems need a water pipe to suction cold water. Cold water pipes are very long, for example more than 600 meters, and may have a length exceeding 1000 meters. However, such water pipes, for example used on the “Tunisia” OTE water pipe in 1935, have problems due to a significant deformation at the junction with the platform on which the OTE system was installed. The cold water pipe was made from steel with a diameter of about 2.5 meters and a length of 700 meters.

Recent installations use high-density polyethylene for the cold ocean water pipe. However, the diameter of the high-density polyethylene pipes is limited to several meters.

The cold ocean water aspiration pipe may for example be designed so as to withstand extreme environmental conditions, for example the swell and/or currents. Under cyclonic conditions, the swell and the currents become locally stronger. The current caused by the wind can thus reach 3 knots over the operating zone. This surface current caused by the wind next decreases with the depth to reach a zero value at about −50 meters. The first meters of the pipe and its connection with the platform are therefore critical points. In earlier systems, the problems encountered arise from an increased deformation at the connection of the cold ocean water pipe to the platform, which caused the total or partial loss of that pipe.

To offset this problem, document FR-A-2,978,979 describes a flexible pipe that comprises a plurality of modular sections, each section comprising two connecting rings, a membrane and tie rods. Document EP-A-2,585,677 describes a pipe formed by a plurality of flexible modular elements connected by connecting rings. Tie rods reinforce the structure of the membrane. However, such devices are relatively inconvenient to implement, since the membranes of these pipes may be made fragile by the tension of the tie rods.

There is a need for a water pipe having an economically profitable cost and that is relatively convenient to manufacture, place and disassemble, able to withstand extreme environmental conditions, and makes it possible to transfer large ocean water flow rates.

### SUMMARY OF THE INVENTION

To that end, the present invention relates to a modular section of a water pipe of the aforementioned type, in which the section further comprises a series of rings extending along the axial direction of the tubular space, the series of rings comprising two end rings, each end ring being at a separate end of the section in the axial direction, the deformable membrane being fastened to the end rings, and at least one central ring, arranged between the two end rings, and cables connecting each ring to the closest ring in the axial direction.

The section according to the invention may include one or more of the following features, considered alone or according to any technically possible combination(s):
each cable includes a first end and a second end each connected to an end ring or to a central ring, the ends being angularly evenly distributed over each ring.
each cable includes a first end connected to a first central ring and a second end connected to an end ring or a second central ring and for each cable, the first end is angularly offset relative to the orthogonal projection of the second end of the first central ring, by an angle smaller than 360°/n where n is the number of cables connecting the same first central ring and the same second central ring or the same end ring to one another.
each ring includes a plurality of fastening points for the cables, at each fastening point of a central ring and for each end, the ends of four cables are combined, two cables being connected to one central ring and two other cables being connected to another central ring or to an end ring, and at each fastening point of an end ring, the ends of two cables are combined.
the section is deformable between a working position and an idle position and the central rings are arranged so that, when the section is in the working position, the deformable membrane is in contact with at least one central ring, and when the section is in the idle position, at least one central ring defines an annular space with the membrane.
the cables are deformable between a tensed state and a relaxed state, and each central ring has an outer surface, and when the section is in the working position, the cables are relaxed, and each central ring is in contact with the membrane over its entire outer surface.
the series of rings includes at least two central rings situated between the two end rings and the cables are deformable between a tensed state and a relaxed state, and, when the section is in the idle position of the section, the cables connecting each central ring to the closest central ring in the axial direction are tensed and the cables connecting a central ring to one of the two end rings are tensed.
the number of cables connecting two successive rings is greater than or equal to six.
the series of rings includes at least two central rings situated between the two end rings, and the central rings are identical and the central rings have the same axis of symmetry, the direction of the axis of symmetry being the axial direction of the section.
the number of cables connecting two successive rings is greater than or equal to four, the series of rings includes at least two central rings, each ring includes a plurality of fastening points for the cables, at each fastening point of a central ring and for each end, the ends of four cables are combined, two cables being connected to one central ring and two other cables being connected to another central ring or to an end ring, and at each fastening point of an end ring, the ends of two cables are combined.

The invention also relates to a water pipe comprising a plurality of sections as previously described, the end rings of the successive sections being alongside and fastened to one another.

Furthermore, the invention also relates to an ocean thermal energy system comprising at least one pipe, in particular a water riser as previously described, the pipe having a main axis along the axial direction, the axis of the pipe being arranged vertically.

### BRIEF DESCRIPTION OF THE DRAWINGS

The invention will be better understood upon reading the following description, provided solely as an example and done in reference to the appended drawings, in which:

FIG. 1 diagrammatically shows an example OTE system with a closed cycle;

FIG. 2 shows a diagrammatic side view of a floating platform of an OTE system according to one embodiment of the invention;

FIG. 3 shows a diagrammatic perspective view of a water pipe section of the platform of FIG. 2 in an idle position;

FIG. 4 shows a diagrammatic perspective view of a water pipe section of FIG. 3 in a working position;

FIG. 5 shows a diagrammatic perspective view of a water pipe section of FIG. 3 in a retracted position for storage and transport; and

FIG. 6 is a diagrammatic view of a portion of the pipe section of FIG. 3, seen from above.

### DETAILED DESCRIPTION OF THE INVENTION

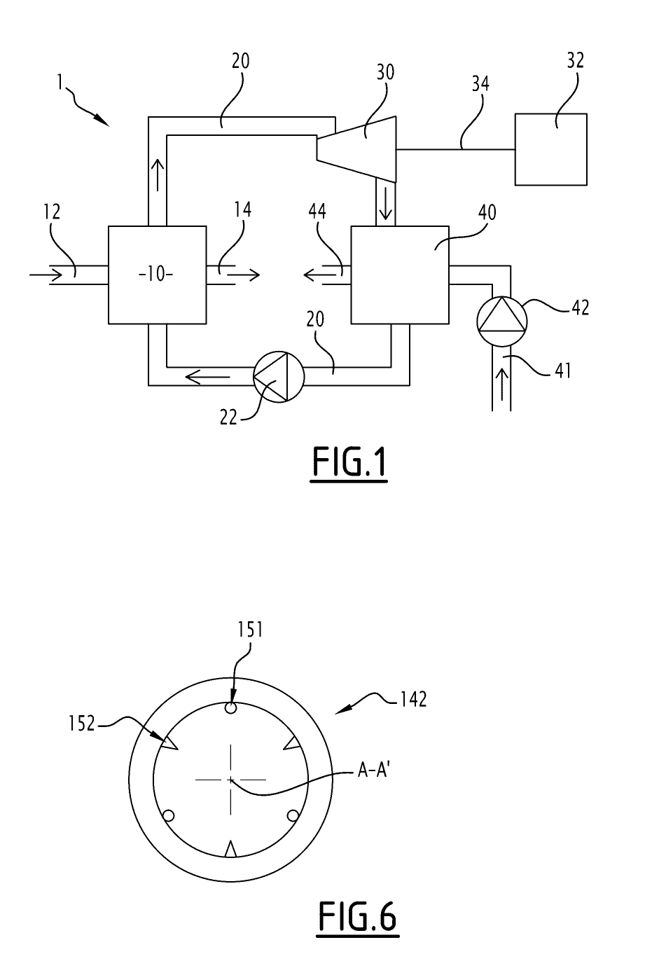

FIG. 1 diagrammatically shows an example OTE system 1 with a closed cycle; The present invention also applies to OTE systems with an open cycle or a hybrid cycle.

The OTE system 1 comprises an evaporator 10 that is supplied with a hot fluid, for example surface water, through a supply hose 12. The hot fluid is used in the evaporator 10 to evaporate a working fluid circulating in a closed circuit 20. The working fluid, for example ammonia, is driven in the closed circuit 20 by a working fluid pump 22.

After having traversed the evaporator 10, the hot fluid is discharged into the sea through a discharge hose 14. The discharge hose 14 is sometimes also called discharge pipe.

The working fluid evaporated in the evaporator 10 under high pressure is brought toward an expansion turbine 30 that is connected to a current generator 32 by a shaft 34. In the turbine 30, the working fluid is expanded. Next, the working fluid is brought toward the condenser 40 to be cooled and condensed and next brought by the working fluid pump 22 toward the evaporator 10 again. The condenser 40 is supplied with a cold fluid, which is very deep ocean water brought up by a cold ocean water pipe 41. The cold fluid is driven by a cold fluid pump 42 that brings the fluid toward the condenser 40. The heated fluid is next discharged into the sea through a discharge hose 44. In the example illustrated in FIG. 1, the cold fluid pump 42 is arranged at the upper part of the cold ocean water pipe 41, or downstream from the cold ocean water pipe 41. In this case, the cold ocean water pipe 41 works by vacuum.

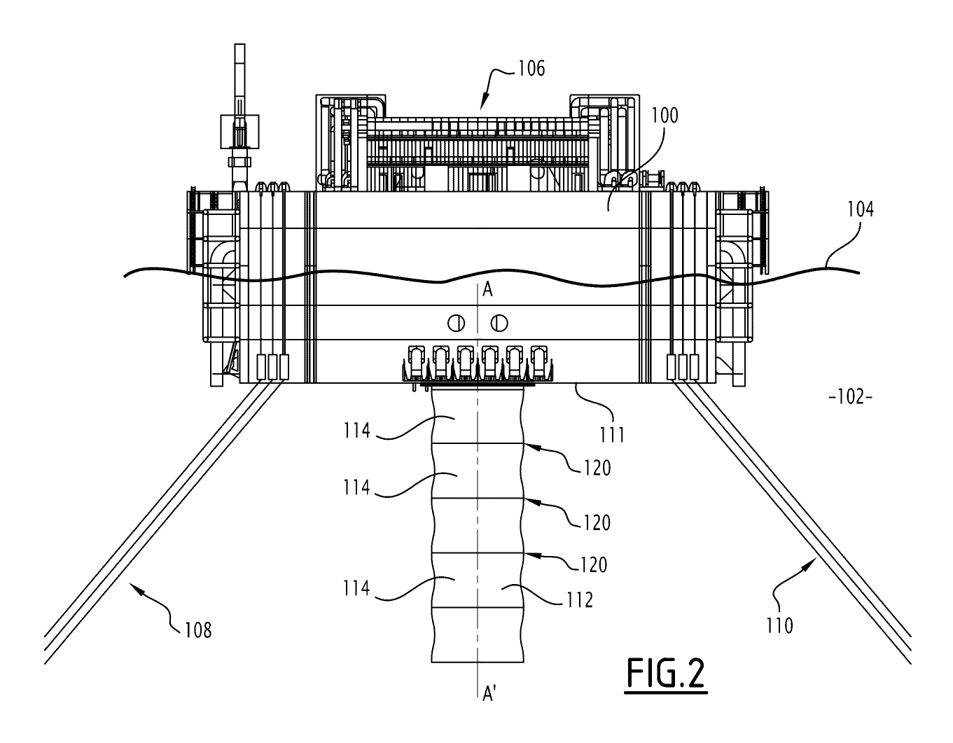

FIG. 2 shows a floating platform 100 in ocean water 102. The platform 100 floats in the ocean water 102 having a surface 104. An OTE system 106 is arranged on the platform 100. In one alternative, the platform 100 has another form, for example the form of a barge. The platform 100 is kept approximately in the same location by anchoring means 108, 110, which connect the platform to the bottom of the ocean. A cold ocean water pipe 112 is fixed to the bottom 111 of the platform 100. The cold ocean water pipe 112 is made up of a plurality of modular sections 114 that are fastened to one another along an axial direction AA′. Based on the operating site, the length of the cold ocean water pipe 112 reaches a depth of about 1100 meters. In one alternative, the OTE system 106 comprises several cold water pipes 112 instead of only one. If there is only one cold ocean water pipe 112, the diameter of the cold ocean water pipe 112 is comprised between 1 meter and 15 meters. The diameter of the cold ocean water pipe 112 depends on the power of the OTE system 106.

As illustrated in FIG. 2, the cold ocean water pipe 112 is designed modularly. The sections 114 of the cold ocean water pipe 112 are manufactured separately on land, transported to the operating location, and assembled and deployed from the platform 100 or from another platform, barge or boat.

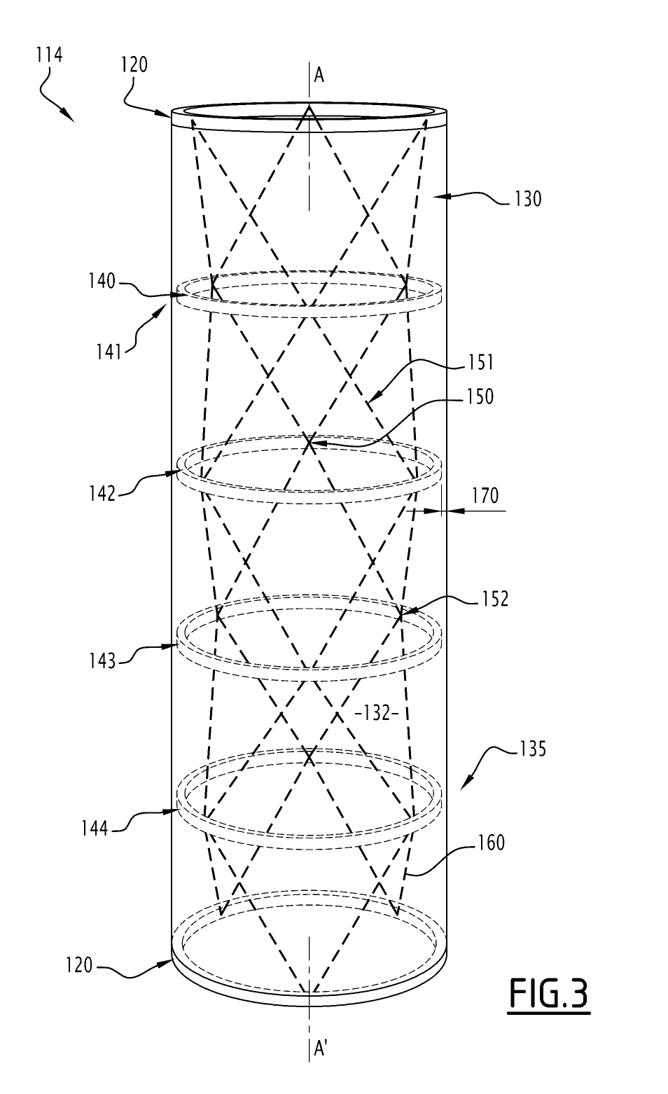

The sections 114 of the cold ocean water pipe 112 will be described more specifically in reference to FIGS. 3 to 6. The cold ocean water pipe 112 is fixed directly below the platform 100 and maintained with minimal vertical tension to avoid risks of relaxation in dynamic behavior along the axial direction. Furthermore, in one embodiment, the cold ocean water pipe 112 should be ballasted at its lower end to limit the deformation of the cold ocean water pipe 112 caused by the vacuum and to limit the impact of the current on the movement of the cold ocean water pipe 112. In one embodiment, the cold ocean water pipe 112 is free at its end in the bottom part.

In the rest of this document, the terms “upper” and “lower” are to be understood relative to the circulation direction of water in the pipe formed by the modular sections when it is mounted on the OTE platform.

FIGS. 3 to 6 illustrate one example modular water pipe section 114 according to the invention.

The section 114 comprises two end rings 120, a membrane 130 and a series 135 of central rings 140 connected by cables 150, 160. In the rest of the description, the two end rings 120 are called flanges.

The section 114 is modular. This means that the arrangement of several sections 114 is able to form a pipe like the cold ocean water pipe 112 of FIG. 2.

The section 114 is generally cylindrical with a circular base. Its generatrix is along the axial direction AA′. The section 114 extends between an upper end 116 and a lower end 118.

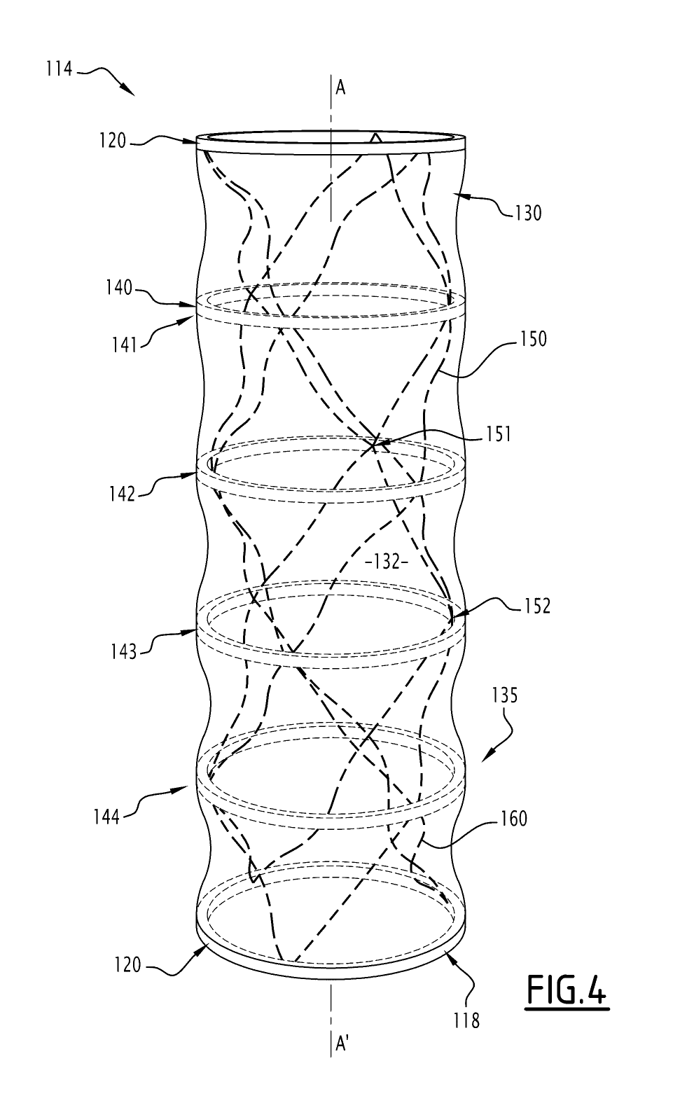

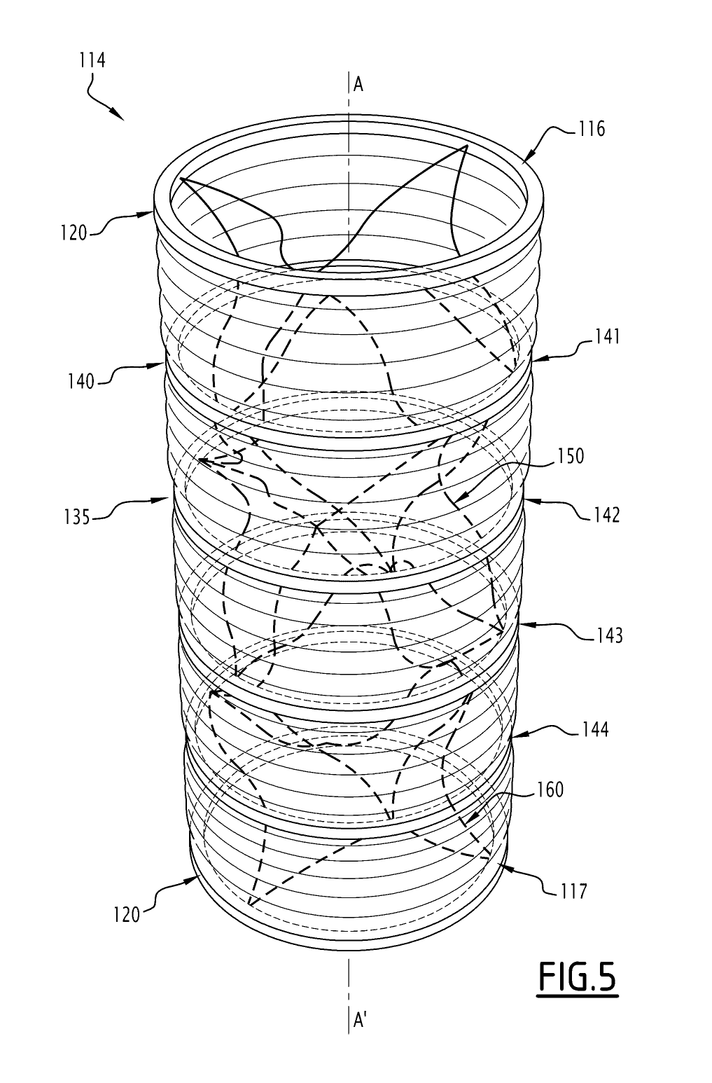

The section 114 is bendable along the direction AA′. The section 114 is deformable between an idle deployed position, called idle position and shown in FIG. 3, a working deployed position, called working position and shown in FIG. 4, and a retracted position for storage, shown in FIG. 5. The different positions of the section 114 will be outlined later in the description.

Each flange 120 is at a separate end 116, 118 of the section 114 along the axial direction AA′. The flange 120 located at the upper end 116 of the section 114 is called upper flange. The flange 120 located at the lower end 118 of the section 114 is called lower flange.

The flanges 120 are annular. Advantageously, the flanges 120 have a diameter between 1 and 15 meters. The flanges 120 have the same axis of symmetry, the direction of the axis of symmetry being the axial direction AA′ of the section 114.

In one embodiment, the flanges 120 have a normal-profile I-beam (IPN) profile. For example, the flanges 120 have an IPN profile of 800 millimeters by 400 millimeters.

The flanges 120 of two different sections 114 can be attached to one another. The assembly of the lower flange 120 of a section 114 with an upper flange 120 of another section 114 makes it possible to form a pipe made up of two sections 114. It is thus possible to choose the number of sections 114 to be assembled to obtain the desired cold ocean water pipe 112 length based on the application. The assembly of two flanges 120 is done so as to preserve sealing between the inside of the two assembled sections 114 and the outside water.

In the example shown in FIG. 2, all of the flanges 120 of a cold ocean water pipe 112 have the same characteristics irrespective of their depth. In another embodiment, the shape of the flanges 120 is optimized, in particular their profile, based on their position in the cold ocean water pipe 112. This means that for each flange 120, the shape of the flange is adapted to the vacuum in the cold ocean water pipe 112, which decreases with the depth.

The flanges 120 are infinitely rigid with respect to the membrane 130.

The flanges 120 are made from concrete. Alternatively, the flanges 120 are made from a material such as steel, titanium, a composite material or the like.

The membrane 130 extends between the lower flange 120 and the upper flange 120. The membrane 130 is fastened to the flanges 120, for example tightly.

The membrane 130 has a generally cylindrical shape with a circular base. Its generatrix is along the axial direction AA′ of the section 114. The membrane 130 encompasses a tubular space 132 along the direction AA′. The tubular space 132 is preferably a space of revolution around the axial direction AA′.

The membrane 130 is able to conduct water to the inside of the tubular space 132.

The membrane 130 is deformable.

The membrane 130 is able to withstand the vertical forces related to the mass of the cold ocean water pipe 112.

The membrane 130 is able to separate the water present in the tubular space 132 from the water present outside the membrane 130. The membrane 130 performs a sealing function. The membrane 130 is impermeable to water.

The material of the membrane 130 is a textile, for example a synthetic textile.

The series of rings 135 extends along the axial direction AA′ in the tubular space 132. In the illustrated example, the series of rings 135 comprises two flanges 120, four central rings 140, end cables 150 and intermediate cables 160.

The central rings 140 are situated in the tubular space 132 between the two flanges 120 of the section 114.

The central rings 140 have the same axis of symmetry, the direction of the axis of symmetry being the axial direction AA′ of the section 114.

The central rings 140 are circular. The diameter of the central rings 140 is preferably comprised between 1 and 15 meters. In the example, the central rings 140 are identical. Each central ring 140 has an outer surface in the form of an annular surface.

The central rings 140 are infinitely rigid with respect to the membrane 130.

The distance between two central rings 140 is defined as the distance between a point of the central ring 140 and its projection along the axial direction AA′ in the plane of the other central ring 140. Likewise, the distance between a central ring 140 and a flange 120 is defined as the shortest distance between a point of the central ring 140 and its projection along the axial direction AA′ in the plane of the flange 120. In the example, the distance between two successive central rings 140 of the series of rings 135 and the distance between a flange 120 and the closest central ring 140 is the same over the entire length of the section 114. The distance between two successive rings 120, 140 is advantageously comprised between 0.5 and 8 meters. The

The central rings 140 are arranged so that, when the section 114 is in the working position, the deformable membrane 130 is in contact with at least one central ring 140, and when the section 114 is in the idle position, at least one central ring 140 defines an annular space 170 with the membrane 130. This means that the shape and the distance between the central rings 140 is adapted to the dimensions of the section 114 and the deformation of the membrane 130 during operation.

In the example shown in FIG. 3, the section 114 is in the idle position, each central ring 140 defining an annular space 170 with the membrane 130. Each annular space 170 completely surrounds a central ring 140. The dimension of the annular space 170, i.e., the shortest radial distance between a point of the outer surface of the central ring 140 and the membrane 130, is comprised between 10 and 200 mm. In such a situation, the absence of direct links between the membrane 130 and the central rings 140 should be noted.

When the section 114 is in the working position, all of the central rings 140 are in contact with the membrane 130 over their entire outer surface according to the example of FIG. 4.

For each flange 120, the central ring 140 closest to the flange 120 is defined as the central ring 140 for which the distance between the central ring 140 and the flange 120 along the axial direction AA′ is the shortest. Likewise, for each central ring 140, the closest central ring 140 is the central ring 140 for which the distance to the central ring 140 considered along the axial direction AA′ is the shortest.

For the rest of this document and for ease of understanding, the central rings 140 of the series 135 are sequenced. The first ring 141 is the central ring 140 closest to the upper flange 120. The second ring 142 is the lower central ring 140 closest to the first ring 141. The third ring 143 is the lower central ring 140 closest to the second ring 142. The fourth ring 144 is the central ring 140 closest to the lower flange 120.

The intermediate cables 150 connect the adjacent central rings 140 in the series 135 to one another. The arrangement of the intermediate cables 150 is shown in FIG. 3.

Six intermediate cables 150 connect the first ring 141 to the second ring 142, six intermediate cables 150 connect the second ring 142 to the third ring 143, and six intermediate cables 150 connect the third ring 143 to the fourth ring 144.

Each intermediate cable 150 includes a first end 151 connected to an upper central ring 140 and a second end 152 connected to a lower central ring 140.

The intermediate cables 150 are flexible. The intermediate cables 150 are deformable between a tensed state and a relaxed state.

In one embodiment, the intermediate cables 150 are made from a synthetic material, for example comprising high-strength polyethylene, aramid, polyamide or the like.

The end cables 160 have properties similar to the intermediate cables 150; only the differences will be outlined.

Six end cables 160 connect the upper flange 120 to the first ring 141 and six end cables 160 connect the lower flange 120 to the fourth ring 144. The end cables 160 differ from the intermediate cables in that one of their ends is connected to a flange 120 instead of a central ring 140.

On each central ring 140, the ends 151, 152 of the intermediate cables 152 are angularly evenly distributed.

For each intermediate cable 150, the first end 151 is angularly offset relative to the orthogonal projection of the second end 152 on the upper central ring 140. In the illustrated example, the angular offset is 60° (60 degrees). This angular offset value is equal to 360°/n, where n is the number of cables 150 connecting the lower ring 140 to the upper ring 140.

Each central ring 140 includes three fastening points for the cables 150, 160. This number of fastening points is equal to n/2, where n is the number of cables 150 connecting the central ring 140 to the lower or upper central ring 140. At each fastening point of a central ring 140, the ends 151, 152 of four cables 150, 160 are combined, two cables 150 being connected to one ring 120, 140 and two other cables 150, 160 being connected to another ring 120, 140.

FIG. 6 illustrates the arrangement of the fastening points for two successive central rings 142, 143. FIG. 6 shows the second ring 142 with three fastening points shown by circles as well as the orthogonal projections of the three fastening points of the third ring 143 on the second ring 142 shown by triangles. The fastening points of the second ring 142 are angularly evenly distributed on the second ring 142 and spaced apart by 120°. The angular offset of the fastening points of the second ring 142 and the orthogonal projection of the fastening points of the third ring 143 is 60°.

This is according to what is illustrated in FIG. 3, i.e., two intermediate cables 150 connected to the third ring 143 at adjacent fastening points and two intermediate cables 150 connected to the first ring leave from each fastening point of the second ring 142. Two cables leave from each fastening point of the second ring 142 toward two adjacent points of the third ring 143, and vice versa.

The arrangement of the ends of the end cables 160 on each flange 120 is similar to the arrangement on a central ring 140.

Each flange 120 thus includes three fastening points for the cables 160 that are angularly evenly distributed. The fastening points are angularly offset by 60° relative to the orthogonal projection of the fastening points of the closest central ring 141, 144 of the flange 120 in question.

Two cables 160 leave from each fastening point of the upper flange 120, connecting it to the first ring 141. Two cables 160 leave from each fastening point of the upper flange 120, connecting it to the first ring 144.

This arrangement of the cables 150, 160 makes it possible to avoid any contact between the cables 150, 160 of the series of rings 135 and the membrane 130 when the section 114 is in the idle position or in the working position. The absence of contact between the membrane 130 and the cables 150, 160 makes it possible to avoid the wear of the membrane 130 or the cables 150, 160 by rubbing.

In one embodiment, several cables 150, 160 are made by a same cable or wire that extends from the upper flange 120 to the lower flange 120, passing through the fastening points of the different central rings of the series of rings 135. The cable or wire then has a zigzag shape around the circumference of the section 114 of the pipe 112.

The operation of the section 114 will now be described by outlining the different positions of the section 114, illustrated in FIGS. 3 to 5.

FIG. 3 shows a diagrammatic side view of a section 114 in the idle position. The idle position corresponds to the position of the section 114 when the cold ocean water pipe 112 is stopped, i.e., when there is no water circulation in the cold ocean water pipe 112.

In the idle position of the section 114, the intermediate cables 150 are tensed and the end cables 160 connected to one of the two flanges 120 are tensed. For example, when the section 114 is a module of a pipe mounted on the platform, the end cables 160 of the upper flange 120 and the intermediate cables 150 are tensed. The end cables 160 of the upper flange and the intermediate cables 150 bear the weight of the series of rings 135. The tension in the cables depends solely on the weight of the rings 120, 140. There is thus no outside force from the other elements of the section 114 on the rings 120, 140 in this situation.

In one embodiment, when the section 114 is in the idle position, the end cables 160 of the lower flange 120 are expanded to facilitate the placement of the series of rings 135 in the position set out for operation.

In this idle position of the section 114, the membrane 130 is tensed between the two flanges 120 and the tubular space 122 defined by the membrane 130 is cylindrical. In this idle position of the section 114, there is a space 170 between the central rings 140 and the membrane 130.

Alternatively, the frictional force related to the contact between the central rings 140 and the membrane 130 is low before the weight of the central rings 140 when the section 114 is in the idle position.

FIG. 4 shows a diagrammatic side view of a section 114 in the working position. The working position is for example the position of the section 114 when the cold ocean water pipe 112 is working by vacuum. In this case, the cold fluid pipe 42 is installed in the platform 100. The pump is arranged at the top of the pipe 112 and works by aspiration. The aspiration causes a vacuum in the pipe 112.

The height of the section 114 in the working position is shorter than the height of the section 114 in the idle position.

In this working position of the section 114, the membrane 130 is deformed under the effect of the pressure difference between the water inside the tubular space 122 and the water outside the section 114. The membrane 130 is then in contact with the central rings 140. The contact between the central rings 140 and the membrane 130 is for example over the entire outer surface of the central rings 140.

In this working position of the section 114, the central rings 140 are kept in position by the membrane 130. As a result, the weight of the central rings 140 is supported by the membrane 130. In this working position of the section 114, the end cables 160 and the intermediate cables 150 are all relaxed.

Under the effect of the working vacuum, the membrane 130 bears on the central rings 140. The friction forces between the membrane 130 and each central ring 140 are greater than the weight of the central rings 140 and the other outside stresses (current, flexion of the pipe, etc.). The height of the section 114 and the distance between the rings 120, 140 decrease. The cables 150, 160 are thus relaxed.

FIG. 5 shows a diagrammatic side view of a section 114 in the retracted position for storage. The position retracted for storage corresponds to the storage position of the section 114. The height of the section 114 in the retracted position for storage is shorter than the height of the section 114 in the working position. The volume of the section 114 is reduced so as to facilitate its transport and storage. When the sections 114 are stored for transport or in preparation for being traded out, they are maximally compacted.

The cables 150, 160 are relaxed. The distance between the rings 120, 140 is reduced by 1% to 10% relative to the distance between the rings 120, 140 when the section 114 is in the working position.

Alternatively, the addition of spacers between the flanges 120 of the section 114 in the position of the section 114 retracted for storage makes it possible to maintain the structure and avoid crushing of the module. The spacers are placed between the lower flange 120 and the upper flange 120 of each section 114.

The sections 114 according to the invention are pushed in by the presence of central rings 140 in the tubular space 132 formed by the membrane 130. The series of rings 135 makes it possible to stiffen the membrane structure subjected to external pressure. The central rings 140 are kept in place in the section 114 either by cables 150, 160 if the section 114 is in the idle position, or by the membrane 130 if the section 114 is in the working position or the retracted position for storage. The membrane 130 is intact at the central rings 140. “Intact” means that the membrane 130 is not altered by a seam, weld or piercing allowing the maintenance in position of the central rings 140.

Such a section 114 effectively withstands the overpressure, since the local stress between the central rings 140 and the membrane 130 is low in the idle position of the section 114. This means that the stress is low relative to a situation where the rings would be integrated into the membrane through sheaths.

In summary, the invention described above makes it possible to obtain a water pipe having an economically profitable cost and that is relatively convenient to manufacture, place and disassemble, able to withstand extreme environmental conditions. Furthermore, this pipe makes it possible to transfer large ocean water flow rates. The high ocean water flow rate makes it possible to offset the low performance and limit the pressure losses of OTE installations comprising such pipes.

Such a pipe according to the invention is usable in the field of offshore OTE power plants. The invention also applies to other industrial fields requiring the pumping or transport of large fluid flow rates. For example, the invention is applicable to gas liquefaction plants, or artificial upwelling. Such a pipe is also usable to bring cold water up in order to conduct aquaculture, and in particular surface algae cultivation to produce food, cosmetics or biofuels.

In addition to the cited embodiments, the invention allows all alternatives accessible to one skilled in the art. In particular, the invention applies to a different number of central rings 140, a higher number of cables 150, 160 and a different arrangement of cables 150, 160 on the central rings 140 or the flanges 120.

Advantageously, the number of central rings 140 per section 114 is comprised between 1 and 20.

Advantageously, there are six cables 150, 160 between two successive central rings 140 or between a flange 120 and a central ring 140 in order to have a compromise between optimization of the balancing of the series of rings 35 and a decrease in the risks of contact between the cables 150, 160 and the membrane 130. Alternatively, there are more than six cables.

1-11. (canceled)

12. A modular water pipe section, the section comprising:
a deformable membrane able to encompass, in an operational state of the section, a tubular space defining an axial direction to conduct water, the membrane being able to separate the water present in the tubular space from the water present outside the membrane, and
wherein the section further comprises:
a series of rings extending along the axial direction in the tubular space, the series of rings comprising:
two end rings, each end ring being at a separate end of the section along the axial direction, the deformable membrane being fastened to the end rings, and
at least one central ring, arranged between the two end rings, and
cables connecting each ring to the closest ring along the axial direction.

13. The section according to claim 12, wherein each cable includes a first end and a second end each connected to an end ring or to a central ring, the ends being angularly evenly distributed over each ring.

14. The section according to claim 12, wherein:
each cable includes a first end connected to a first central ring and a second end connected to an end ring or a second central ring, and
for each cable, the first end is angularly offset relative to the orthogonal projection of the second end of the first central ring, by an angle smaller than 360°/n where n is the number of cables connecting the same first central ring and the same second central ring or the same end ring to one another.

15. The section according to claim 12, wherein:
the number of cables connecting two successive rings is greater than or equal to four,
the series of rings includes at least two central rings,
each ring includes a plurality of fastening points for the cables,
at each fastening point of a central ring, and for each end, the ends of four cables are combined, two cables being connected to one central ring and two other cables being connected to another central ring or to an end ring, and
at each fastening point of an end ring, the ends of two cables are combined.

16. The section according to claim 12, wherein the section is deformable between a working position and an idle position and the central rings are arranged so that:
when the section is in the working position, the deformable membrane is in contact with at least one central ring, and
when the section is in the idle position, at least one central ring defines an annular space with the membrane.

17. The section according to claim 16, wherein the cables are deformable between a tensed state and a relaxed state, and each central ring has an outer surface, and when the section is in the working position, the cables are relaxed, and each central ring is in contact with the membrane over its entire outer surface.

18. The section according to claim 16, wherein the series of rings includes at least two central rings situated between the two end rings, and the cables are deformable between a tensed state and a relaxed state, and, when the section is in the idle position of the section, the cables connecting each central ring to the closest central ring in the axial direction are tensed and the cables connecting a central ring to one of the two end rings are tensed.

19. The section according to claim 12, wherein the number of cables connecting two successive rings is greater than or equal to six.

20. The section according to claim 12, wherein the series of rings includes at least two central rings situated between the two end rings, and the central rings are identical and the central rings have the same axis of symmetry, the direction of the axis of symmetry being the axial direction of the section.

21. A water pipe comprising a plurality of sections according to claim 12, the end rings of the successive sections being alongside and fastened to one another.

22. An ocean thermal energy system comprising at least one pipe, in particular a water riser according to claim 21, the pipe having a main axis along the axial direction, the axis of the pipe being arranged vertically.
